(19) United States
(12) Patent Application Publication
(10) Pub. No.: US 2010/0170587 A1
(43) Pub. Date: Jul. 8, 2010

(54) FITTING COMPRISING AN EXTENSIBLE SHOWER ATTACHMENT GUIDED IN A MAGNETIC MOUNTING

(75) Inventor: Henning Kaess, Bodman-Ludwigshafen (DE)

Correspondence Address: SUGHRUE MION, PLLC, 2100 PENNSYLVANIA AVENUE, N.W., SUITE 800, WASHINGTON, DC, 20037, US

(73) Assignee: WEIDMANN PLASTICS TECHNOLOGY AG, Rapperswil (CH)

(21) Appl. No.: 12/063,775

(22) PCT Filed: Aug. 10, 2006
(86) PCT No.: PCT/CH06/00422

§ 371 Date: Feb. 14, 2008

(30) Foreign Application Priority Data
Aug. 15, 2005 (DE) 20 2005 013 425.2

(51) Int. Cl. F16K 21/00

(52) U.S. Cl. 137/801

(57) ABSTRACT

Disclosed is a fitting comprising a guiding tube (2) for a flexible conduit (6) and a shower (5, 39, 50, 60) located at one end of the guiding tube (2). Means are provided for removably fastening the shower (5, 39, 50, 60) to the guiding tube (2). Said means encompass two parts which magnetically adhere to each other. A first part (13, 13′, 42, 53, 54, 62) is fixed to the shower (5, 39, 0, 60) while the second part (12, 35) is fixed to the guiding tube. Preferably, the shower is embodied as an extensible shower.

The invention relates to a faucet having a guide tube for a flexible line and having a shower which is arranged at one end of the guide tube, having connecting means for detachably fastening the shower to the guide tube.

Faucets with showers have been known for a long time in the prior art, in particular for kitchens and bathrooms. For kitchens in particular, so-called “pull-down” showers are also known, in which the guide tube is of U-shaped design and the shower head can be pulled out vertically downward. Here, a counterweight which is connected to the flexible line is raised. If the shower head is no longer required, it can be released and, on account of the counterweight, automatically travels back upward and finally bears against the mouth of the guide tube. Here, there is the problem that the shower head, in particular after frequent use, bears against the guide tube with a comparatively large amount of play and therefore in an unsteady manner.

US 2001/0011561 discloses a faucet with a shower in which the shower has an adapter which can be inserted into the mouth of the guide tube. A resiliently elastic sleeve is attached to the adapter, which sleeve is inserted into a peripheral groove of the adapter. Axially running ribs are arranged at the periphery of the resiliently elastic ring. If the adapter is inserted into the mouth of the guide tube, the ribs of the resiliently elastic ring bear against the inner side of the guide tube and should thereby fix the shower to the guide tube with little play and in a secure manner.

US 2002/0170608 presents a further faucet with a shower. In order to mount the shower in the guide tube, a resiliently elastic sleeve is inserted and in particular adhesively bonded therein. Two sealing rings are arranged on an attachment part of the shower at the outside, which sealing rings can be inserted into said sleeve. Suitable fastening of the shower to the guide tube should be ensured as a result of the friction of said sealing rings against the inner side of said sleeve. When pulling the shower head out, the friction force between the sealing rings and said sleeve must be applied. Said force can vary with time and is then either too great or too small.

The invention is based on the object of creating a faucet of the specified type which can be handled in a simple and secure manner and which can additionally be produced in a cost-effective manner.

The object is achieved in a generic faucet in that said connecting means have two parts which adhere to one another magnetically, with a first part being fastened to the shower and the second part to the guide tube. In the faucet according to the invention, the shower is held on the guide tube by magnetic force. A magnetic force of said type can firstly be precisely set, and secondly also does not change after a long period of use. The magnetic force thereby ensures a permanent holding function, since the magnet does not suffer from fatigue. It has also been proven that the conventional counterweight or a spring on the hose could be omitted. The hose is then loaded to a lesser degree. It can thereby be ensured that the shower can always be fixed to the guide tube precisely and substantially without play and that the force for releasing the shower always remains constant. The faucet is preferably designed such that the shower can be pulled out of the guide tube vertically downward. The faucet can however also be designed such that the shower can be pulled out of the guide tube not vertically downward but for example obliquely upward.

Particularly cost-effective production is possible when, according to one refinement of the invention, the first part is a sleeve which is fitted onto an attachment part of the shower. Said sleeve is preferably a threaded sleeve which is screwed onto said attachment part. This results in particularly simple production and assembly.

According to one refinement of the invention, the second part is a ring which is inserted into the guide tube. The second part is preferably fastened in a guide sleeve which is inserted into the guide tube. The fastening of the second part is particularly simple when said second part is latched onto the guide sleeve. The guide sleeve is preferably produced from plastic in an injection-molding process and is preferably latched onto the guide tube.

According to one refinement of the invention, the first part is a ring which is fastened to said attachment part. The fastening takes place according to one refinement by means of latching, and according to a further refinement by means of a sleeve which is screwed onto the attachment part. The first part is in this case fixedly clamped between a shoulder of the attachment part and said threaded sleeve. This permits particularly simple assembly of the shower.

According to one refinement of the invention, the first part is a housing or a housing part of the shower. The housing is in this case produced for example from rust-protected iron or a rust-resistant alloy with a small amount of chrome. The housing part which forms the first part can be embodied as a ring which forms an upper edge of the housing and which is likewise produced from rust-protected iron or a rust-resistant alloy with a small amount of chrome.

The magnet can be formed by the first part or the second part. Said magnet can be a conventional permanent magnet composed of metal or magnetic plastic.

Exemplary embodiments of the invention are explained in more detail below on the basis of the drawing, in which:

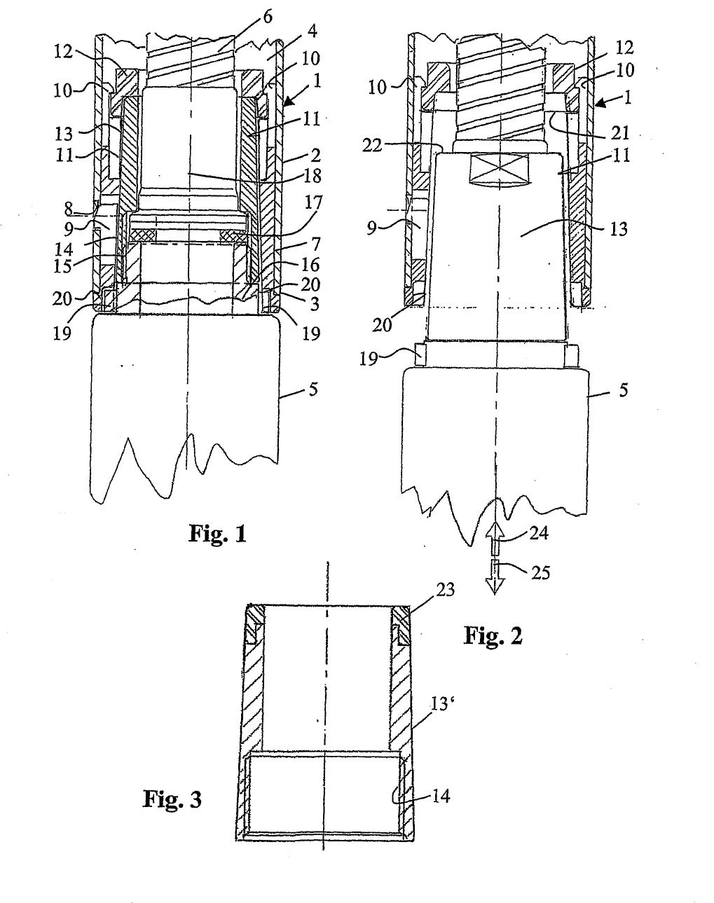

FIG. 1 shows an axial section through the connecting point between the guide tube and shower of a faucet according to the invention,

FIG. 2 shows a section as per FIG. 1, with the shower partially pulled out,

FIG. 3 shows a section through a threaded sleeve according to one variant,

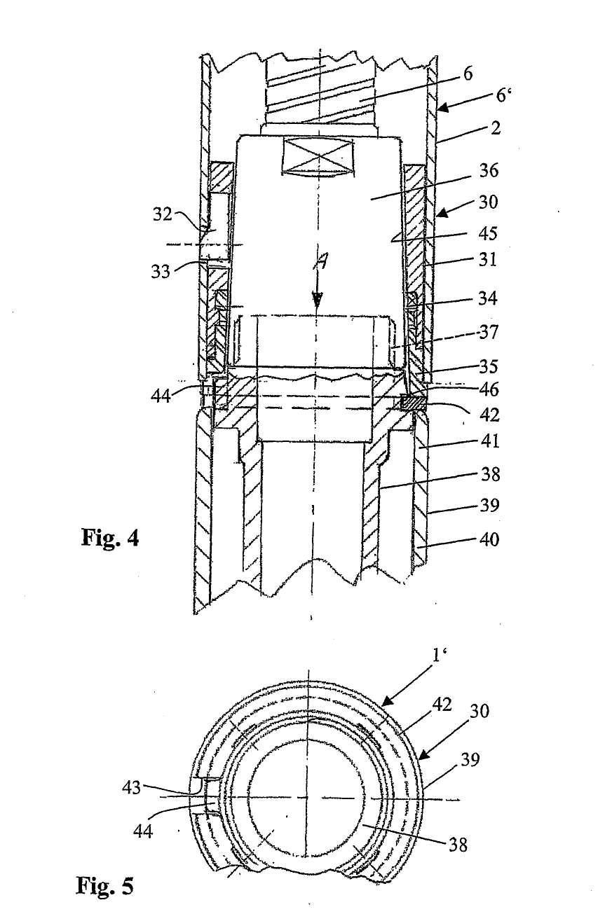

FIG. 4 shows an axial section through a part of a faucet according to the invention according to one variant,

FIG. 5 shows a view of the shower of the faucet as per FIG. 4,

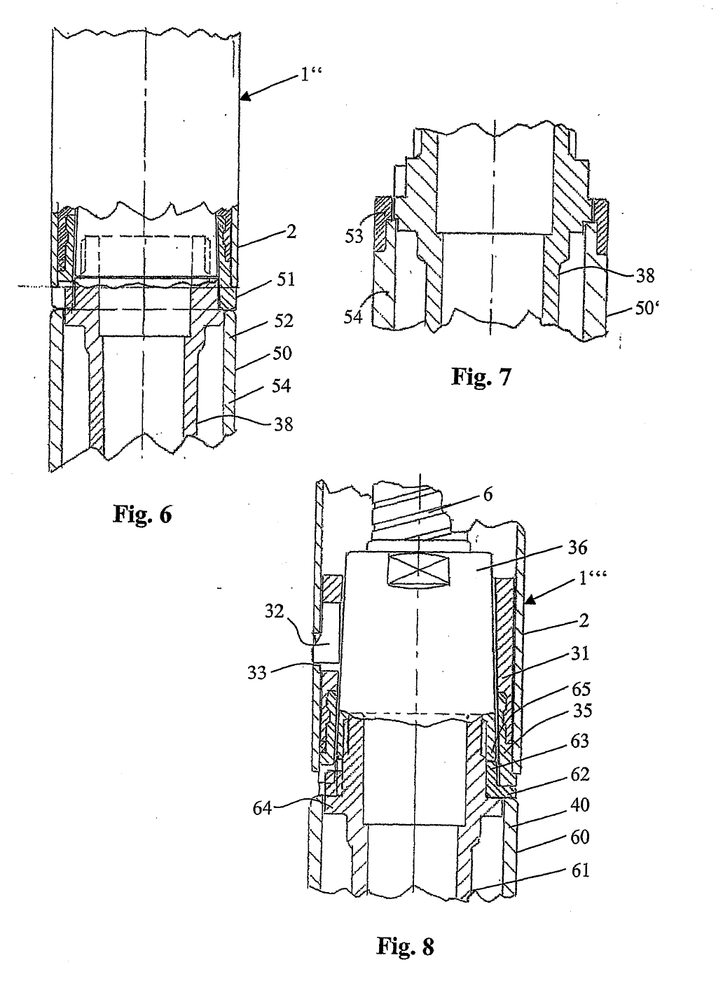

FIG. 6 shows a partial section through a part of a faucet according to a further variant,

FIG. 7 shows a section through a part of a faucet as per FIG. 6, but with a housing according to one variant, and

FIG. 8 shows a section through a part of a faucet according to a further variant.

The faucet 1 shown in FIG. 1 has a shower 5 (merely indicated here) which is preferably embodied as a pull-out shower and which is preferably adjustable between two jet types. Showers 5 of said type or showers are known per se. The shower 5 is connected, in a manner known per se, by means of an attachment part 16 and a connecting sleeve 18 to an encased flexible line 6. Arranged between the attachment part 16 and the connecting sleeve 18 is a sealing ring 17. Here, the line 6 is in particular an encased hose which runs in a movable fashion in a guide tube 2 and which can be connected to a weight or a spring (not shown here). The guide tube 2, of which only the one, front end is shown here, is for example bent into a U-shape. The end which is shown is aligned vertically downward, but can for example also be aligned obliquely upward.

When the shower 5 is used, it is pulled downward by hand in the direction of the arrow 25 as per FIG. 2, counter to the weight mentioned above. Here, the front end of the line 6 can also be pulled out of the guide tube 2, so that the shower 5 can be moved freely during use. After use, the shower 5 is placed back into the position shown in FIG. 1 in the direction of the arrow 24. Here, the shower 5 is pulled upward by means of the weight mentioned above. Said movement is indicated in FIG. 2 by the arrow 24. If the shower 5 is released, it remains in the position shown in FIG. 1. In order that said position is as free from play as possible, the shower 5 has connecting means which bring about a magnetic adhesion in the position of the shower 5 shown in FIG. 1. Said means have a threaded sleeve 13 which forms a first part and which is screwed onto an attachment part 16. For this purpose, the threaded sleeve 13 has an internal thread 14 which is screwed onto an external thread 15 of the attachment part 16. Said threaded sleeve 13 is composed in particular of rust-protected iron or a rust-resistant alloy with a small amount of chrome. Said threaded sleeve 13 extends, as can be seen, over the connecting sleeve 18 proceeding from the shower 5 and upward into a guide sleeve 7 which is preferably produced from plastic. Said guide sleeve 7 bears against a front, free edge 3 of the guide tube 2 and, as can be seen, projects beyond said edge 3. In order to fix the guide sleeve 7 to the guide tube 2, said guide sleeve 7 has at least one latching cam 9 which is detachably latched into an opening 8 of the guide tube 2. In order to position the shower 5, the guide sleeve 7 has two diametrically oppositely situated recesses 20 into which in each case one cam 19 of the attachment part 16 projects.

Fastened to the guide sleeve 7 within the guide tube 2 is a ring 12 which forms a second part of said connection. Said ring 12 is inserted into the guide sleeve 7 from above and is detachably fixed to the guide sleeve 7 by means of at least two oppositely situated latching cams 10. The ring 12 forms a permanent magnet and is produced from a corresponding material, for example from metal or a magnetic plastic. Particularly suitable is a strong permanent magnet, for example with metal from the lanthanides group. As can be seen, the threaded sleeve 13 engages into the ring 12 and bears against the latter. The threaded sleeve 13 thereby adheres magnetically to the ring 12, with the adhesion force being aligned substantially axially with respect to the longitudinal direction of the line 16 and therefore in the direction of the arrows 24 and 25. When the shower 5 is pulled out in the direction of the arrow 25, said adhesion force must be overcome. Said adhesion force is dimensioned such that said force can be comfortably overcome when pulling the shower 5 out, but a secure seat of the shower 5 is nevertheless ensured. The threaded sleeve 13 bears with a shoulder 22 against a shoulder 21 of the ring 12. Since the guide sleeve 7 is securely held in the ring 12, axial play is thereby largely prevented. Radial play is likewise largely prevented by means of the engagement of the threaded sleeve 13 into the ring 12 and by means of the contact of the threaded sleeve 13 against the guide sleeve 7. As can be seen, the guide sleeve 7 has an inner side 11 which narrows conically in the upward direction and against which the threaded sleeve 13 bears in the rest position shown in FIG. 1. Said inner side 11 guides the shower 5 as it is pulled out and placed back in. The shower 5 is additionally fixed and positioned in the rotational direction as a result of the engagement of the cams 19 into the recesses 20. Assembly is very simple. The threaded sleeve 13 is fixed by being simply screwed onto the attachment part 16. The ring 12 can be fastened to the guide sleeve 7 in a very simple and secure manner by being snapped onto the latter. Finally, the guide sleeve 7 can be fastened to the guide tube 2 in a very simple manner by being latched onto the latter. Said parts can also be disassembled in a simple manner. This results in a faucet 1 which is functionally reliable and nevertheless simple to produce.

FIG. 3 shows a sleeve 13′ according to one variant. Said sleeve 13′ is produced substantially from plastic or brass, with a ring 23 composed of rust-protected iron or a rust-resistant alloy with a small amount of chrome forming the upper edge. In the assembled state, the ring 23 then bears correspondingly against the ring 23. The ring 12 is fastened to the threaded sleeve 13′ for example by being adhesively bonded, pressed on or in some other way.

FIGS. 4 and 5 show a faucet 1′ in which a guide sleeve 31 is inserted into the guide tube 2, which guide sleeve 31 is likewise preferably produced from plastic and has an elastically radially deflectable cam 32 which is latched into an opening 33 of the guide tube 2. The guide sleeve 31 has an inner side 45, which tapers conically in the upward direction, and holds a threaded sleeve 36 which is of correspondingly conical design and which is screwed by means of a thread 37 onto an attachment part 38. A housing 40 of a shower 39 is fastened to the attachment part 38. The housing 40 is for example produced from plastic or brass and has an upper encircling edge 41 against which a ring 42 bears. The ring 42 has, as per FIG. 5, a radial slot 43 and is fixed in an encircling groove 46 or by means of latching cams of the attachment part 38. The attachment part 38 also has, as per FIG. 5, a cam 44 which engages into the slot 43 and thereby fixes the ring 42 in the rotational direction. The cam 44 additionally serves for positioning the shower 39 on the guide tube 2 or on the guide sleeve 31. Here, the ring 42 forms the first part which adheres magnetically to a sleeve 35 which is inserted from below, and is in particular latched, into an inner recess 34 of the guide sleeve 31. The sleeve 35 is therefore fixed to the guide tube 2 by means of the guide sleeve 31. As can be seen, the sleeve 35 is fastened to the lower end of the guide sleeve 31 and projects beyond the guide tube 2 at the underside. The sleeve 35 additionally forms a stop for the ring 42 or the shower 39. The sleeve 35 is preferably formed as a magnet and the ring from rust-protected iron or a rust-resistant alloy with a small amount of chrome. Also conceivable is a design in which the ring 42 forms the magnet. In the case of the armature 1′, too, the magnetic force acts in particular axially. Axial play is prevented as a result of the contact of the ring 42 against the sleeve 35. Radial play is likewise largely eliminated by means of the engagement of the threaded sleeve 36 into the guide sleeve 31 which is conical at the inside. The shower 39 can therefore be placed back into a precisely defined and largely play-free position in each case after every use. In addition, production is likewise very simple since the individual parts are comparatively simple and robust and can be connected by means of simple joining, in particular by means of latching.

FIG. 6 shows a faucet 1″ with a shower 50 which has a housing 54 which surrounds the attachment part 38 and has an upper encircling edge 52. The housing 54 forms said first part and is correspondingly produced, at least in the region of the upper edge 52, from rust-protected iron or a rust-resistant alloy with a small amount of chrome. Here, the second part is formed by a sleeve 51 which is of similar design to the sleeve 35. Said faucet 1″ has the particular advantage that a separately-produced first part is not necessary here, since the first part of the magnetic connection is formed by the housing 54 of the shower 50.

FIG. 7 shows a variant of the armature 1″. In said variant, a shower 50′ is provided which has a housing 54′ which is produced largely from plastic or brass, but in which an upper edge is formed by a ring 53 which forms said first part and which correspondingly adheres to the sleeve 35. The ring 53 can be screwed on, adhesively bonded on or fastened in some other way. The radial guidance also takes place here by means of the guide sleeve 31 and the threaded sleeve 36 which is inserted into the guide tube 2.

FIG. 8 shows a faucet 1′″ which has a shower 60 in which an attachment part 61 is provided which is inserted into the above-mentioned housing 40. A ring 62 is placed onto the attachment part 61, which ring 62 rests on an encircling collar 64 of the attachment part 61 and on the top of the housing 40. The ring 62 is preferably pushed onto the attachment part 61 in an adherent manner. Said ring 62 can however also be fixedly connected to the attachment part 61, for example adhesively bonded or pressed or screwed on. As FIG. 8 shows, the ring 62 is approximately L-shaped in cross section and has an encircling wall 63 which engages into the sleeve 35. Here, the ring 62 forms the first part which adheres magnetically to the sleeve 35. As mentioned above, the threaded sleeve 36 is screwed onto the attachment part 61, which threaded sleeve 36 rests with a lower edge 65 on the wall 63. The ring 62 is therefore fixedly clamped between the threaded sleeve 36 and the collar 64. The ring 62 can be fixed by the threaded sleeve 36 alone. The ring 62 can additionally be fixed in the rotational direction, similarly to the ring 42, by means of a slot and a corresponding cam of the attachment part 61. The insertion depth of the shower 60 into the guide tube 2 is determined by the contact of the ring 62 against the sleeve 35. Wear-free, precise positioning of the shower on the guide tube 2 is ensured by means of the magnetic adhesion and the engagement of the threaded sleeve 36 into the guide sleeve 31.

### LIST OF REFERENCE SYMBOLS

| | |
|---|---|
| 1 | Faucet |
| 2 | Guide tube |
| 3 | Edge |
| 4 | Duct |
| 5 | Shower |
| 6 | Line (hose) |
| 7 | Guide sleeve |
| 8 | Opening |
| 9 | Latching cam |
| 10 | Latching cam |
| 11 | Inner side |
| 12 | Ring |
| 13 | Threaded sleeve |
| 14 | Internal thread |
| 15 | External thread |
| 16 | Attachment part |
| 17 | Sealing ring |
| 18 | Connecting sleeve |
| 19 | Cam |
| 20 | Recess |
| 21 | Shoulder |
| 22 | Shoulder |
| 23 | Ring |
| 24 | Arrow |
| 25 | Arrow |
| 31 | Guide sleeve |
| 32 | Cam |
| 33 | Opening |
| 34 | Recess |
| 35 | Sleeve (magnet) |
| 36 | Threaded sleeve |
| 37 | Thread |
| 38 | Attachment part |
| 39 | Shower |
| 40 | Housing |
| 41 | Edge |
| 42 | Ring |
| 43 | Slot |
| 44 | Positioning cam |
| 45 | Inner side |
| 46 | Groove |
| 50 | Shower |
| 51 | Sleeve |
| 52 | Edge |
| 53 | Ring |
| 54 | Housing |
| 60 | Shower |
| 61 | Attachment part |
| 62 | Ring |
| 63 | Wall |
| 64 | Collar |
| 65 | Edge |

1-21. (canceled)

22. A faucet having a guide tube for a flexible line and having a shower which is arranged at one end of the guide tube, having connecting means for detachably fastening the shower to the guide tube, wherein said connecting means have two parts which adhere to one another magnetically, with a first part being fastened to the shower and the second part to the guide tube.

23. The faucet as claimed in claim 22, wherein the first part is a sleeve which is fitted onto an attachment part of the shower.

24. The faucet as claimed in claim 23, wherein the first part is screwed onto the attachment part.

25. The faucet as claimed in claim 22, wherein the second part is a ring which is inserted into the guide tube.

26. The faucet as claimed in claim 22, wherein the second part is fastened in a guide sleeve which is inserted into the guide tube.

27. The faucet as claimed in claim 26, wherein the second part is latched to the guide sleeve.

28. The faucet as claimed in claim 26, wherein the guide sleeve is latched to the guide tube.

29. The faucet as claimed in claim 22, wherein the first part is a ring which is fitted onto an attachment part of the shower.

30. The faucet as claimed in claim 29, wherein the first part is a slotted ring.

31. The faucet as claimed in claim 29, wherein the attachment part has a cam which engages into a slot of the first part.

32. The faucet as claimed in claim 29, wherein the second part is a sleeve which is inserted into the guide tube.

33. The faucet as claimed in claim 32, wherein the second part is fastened into a guide sleeve which is inserted into the guide tube.

34. The faucet as claimed in claim 33, wherein the second part is latched with the guide sleeve.

35. The faucet as claimed in claim 22, wherein the first part forms a housing or a housing part of the shower.

36. The faucet as claimed in claim 35, wherein the first part is a ring which forms an upper edge of the housing of the shower.

37. The faucet as claimed in claim 35, wherein the second part is a sleeve or a ring which is inserted into the guide tube and projects beyond the latter at its mouth.

38. The faucet as claimed in claim 22, wherein the first part is a ring which is fastened to an attachment part of the shower.

39. The faucet as claimed in claim 38, wherein the first part is fixed by means of a threaded sleeve to the attachment part.

40. The faucet as claimed in claim 38, wherein the second part is a ring or a sleeve.

41. The faucet as claimed in claim 22, wherein the shower has a conical sleeve which engages into a guide sleeve which is correspondingly conical at the inner side.

42. The faucet as claimed in claim 22, wherein the first part and/or the second part is of annular or sleeve-shaped design.
